(19) United States
(12) Patent Application Publication
(10) Pub. No.: US 2026/0008661 A1
(43) Pub. Date: Jan. 8, 2026

(54) OFFROAD RECOVERY DEVICE

(71) Applicant: Gary Lloyd Howell, Fort Lupton, CO (US)

(72) Inventor: Gary Lloyd Howell, Fort Lupton, CO (US)

(21) Appl. No.: 19/057,821

(22) Filed: Feb. 19, 2025

Related U.S. Application Data
(60) Provisional application No. 63/668,122, filed on Jul. 5, 2024.

(51) Int. Cl. B66F 19/00

(52) U.S. Cl. CPC B66F 19/00

(57) ABSTRACT

An apparatus for recovery of a vehicle may include a base. The apparatus may include a boom that extends away from the base and is rotatably and removably coupled, at a first end, to the base. The apparatus may include a yoke removably coupled with the boom at a second end of the boom. The apparatus may include multiple line attachment points coupled with the yoke, where a first line attachment point of the multiple line attachment points that is coupled with a first side of the yoke receives a first line coupled with the vehicle, and where a second line attachment point of the multiple line attachment points that is coupled with a second side of the yoke receives a second line coupled with a first anchor point. The source of the pulling force may be applied at any point along the first line or the second line.

### CROSS REFERENCES

The present Application for Patent claims priority to U.S. Provisional Patent Application No. 63/668,122, by Gary Lloyd Howell, entitled “S.S.M.A.R.T. (Snow, Sand & Mud Adaptive Recovery Tool)” filed on Jul. 5, 2024, assigned to the assignee hereof, and expressly incorporated by reference herein.

### FIELD OF TECHNOLOGY

The present disclosure relates generally to recovery of a vehicle, and more specifically to an off-road recovery device for recovering vehicles.

### BACKGROUND

Offroad vehicles often encounter difficult terrain, which may cause a vehicle to become stuck or otherwise immobile. Various recovery approaches have been employed, but may be improved.

### SUMMARY

The described techniques relate to improved methods, systems, devices, and apparatuses that support off-road recovery devices. Generally, the subject matter described herein provides for an apparatus for recovery of a vehicle, which may include a base. The apparatus may further include a boom that extends away from the base and is rotatably and removably coupled, at a first end, to the base. The apparatus may further include a yoke removably coupled with the boom at a second end of the boom. The apparatus may further include multiple line attachment points coupled with the yoke, where a first line attachment point of the multiple line attachment points that is coupled with a first side of the yoke receives a first line coupled with the vehicle, and where a second line attachment point of the multiple line attachment points that is coupled with a second side of the yoke receives a second line coupled with a first anchor point.

### BRIEF DESCRIPTION OF THE DRAWINGS

FIG. 1 shows examples of off-road recovery scenarios and an off-road recovery device in accordance with examples as disclosed herein.

FIG. 2 shows an example of a boom of an off-road recovery device in accordance with examples as disclosed herein.

FIG. 3 shows an example of a base assembly of an off-road recovery device in accordance with examples as disclosed herein.

FIG. 4 shows an example of a storage state of an off-road recovery device in accordance with examples as disclosed herein.

FIG. 5 shows an example of storage states of an off-road recovery device in accordance with examples as disclosed herein.

FIG. 6 shows an example of an off-road recovery scenario in accordance with examples as disclosed herein.

FIG. 7 shows an example of an off-road recovery scenario in accordance with examples as disclosed herein.

### DETAILED DESCRIPTION

Offroad vehicles often encounter difficult terrain and obstacles, which may include snow, sand, mud, boulders, steep slopes, and other obstacles. In some cases, such vehicles may become immobilized in a variety of manners and recovery of the vehicle may need to be performed. Some approaches to vehicle recovery may involve the use of another vehicle to extricate the immobilized vehicle. However, these and other approaches to vehicle recovery may cause damages to bumpers, frames, body panels, or other portions of a vehicle, including attachment points. Such damage may be a result of the large amounts of force exerted to recover the vehicle and overcome both the inertia of the vehicle itself as well as “plowing” effects, in which dirt, mud, snow, sand, or other environmental elements accumulate against the stuck vehicle and hinder recovery. Such “plowing” effects may appear in cases in which the force on the stuck vehicle is exerted substantially horizontally, along a path of travel of the vehicle, or at or near bumper-level. Further, other approaches to vehicle recovery often involve the use of a second vehicle, which may not be an option if a vehicle is travelling alone.

In some examples, the recovery device may include a base that is placed on the ground and a boom attached to the base. The boom may include one or more attachment points to which one or more lines (e.g., straps, chains, ropes, or other recovery lines) may be attached. A line may be attached from the device to a vehicle and another line may be attached from another attachment point to an anchor point. The boom may extend away from the base and the one or more attachment points may be located at an end of the boom distal to an end that is coupled with the base. In this way, the lines attached to the attachment points may be directed such that the forces exerted on the vehicle may include a vertical component that may aid in lifting the vehicle (e.g., in addition to pulling the vehicle) as the pulling force is exerted. The recovery device may accommodate both a pulling force that originates at or near the vehicle or a pulling force placed elsewhere. Such pulling forces may be, but are not limited to, a winch, a come-along, a jack, a farm jack, a pully system, another entity, device, method, or mechanism for exerting a force, or any combination thereof that may be used to lift, pull, or lift and pull the vehicle during recovery operations. With at least these features (as well as others described or depicted herein), the recovery device may redirect a pulling force to both pull and lift the vehicle at the same time, reducing “plowing” effects, overcoming suction effects from the terrain, and allowing recovery of the vehicle with a variety of pulling forces and without the aid of another vehicle (though the use of another vehicle may also benefit from the use of the recovery device). The recovery device also may be used to recover, dislodge, or move any vehicle or object, including a passenger vehicle, an off-road vehicle, an all-terrain vehicle (ATV), a tractor, a snowmobile, a 4×4 vehicle, a log, a fence post, a game animal, stubborn flora, or any other vehicle or object. The recovery device is capable of being disassembled and packed into a storage state for easy transport and portability when not needed and may be assembled quickly and easily in a recovery situation.

Aspects of the disclosure are initially described in the context of the recovery of a vehicle. Aspects of the disclosure are then described with reference to off-road recovery scenarios, an example boom of an off-road recovery device, a base assembly of an off-road recovery device, storage states of off-road recovery devices, and recovery scenarios.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

Aspects of the disclosure are described with reference to example off-road recovery devices. Aspects of the disclosure are further illustrated by and described with reference to apparatus diagrams, system diagrams, and flowcharts that relate to off-road recovery devices.

It should be appreciated by a person skilled in the art that one or more aspects of the disclosure may be implemented to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

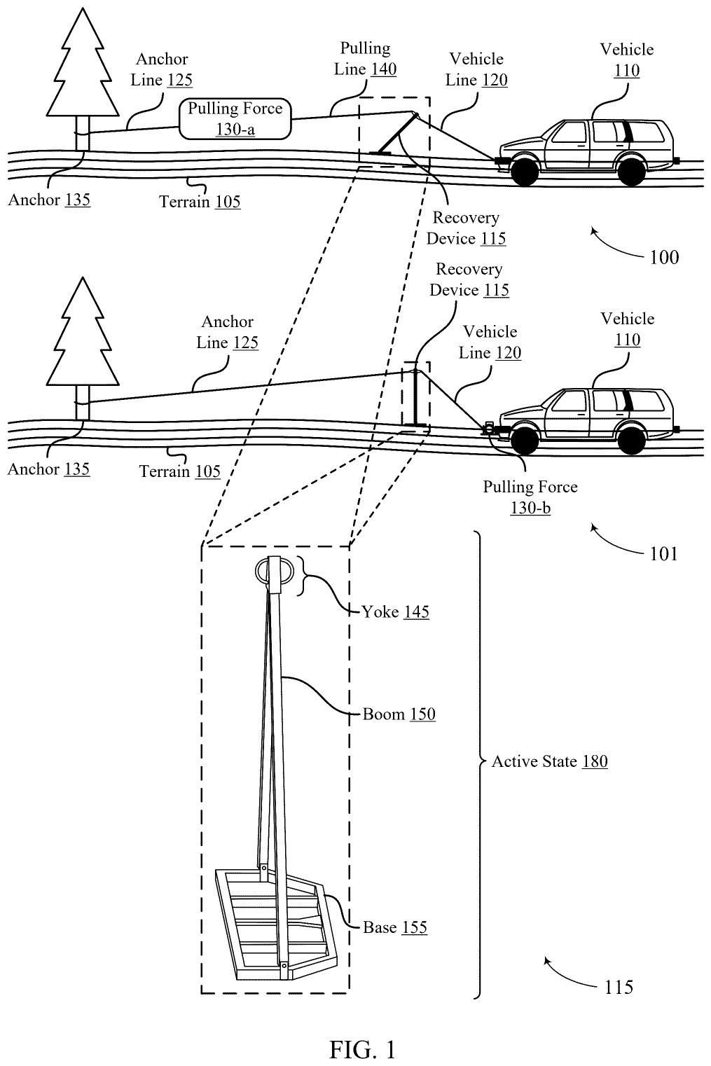

FIG. 1 shows an example of a first recovery scenario 100 and a second recovery scenario 101 in which the recovery device 115 may be used in accordance with examples as disclosed herein.

The recovery device 115 may include a base 155 that may be placed on the terrain 105. The recovery device 115 includes a boom 150 that may extend away from the base 155 and may be rotatably coupled with the base 155 to allow for movement of the boom 150 when desired. The yoke 145 may be coupled with the boom 150 or may be a portion of the boom 150. The yoke 145 may include one or more attachment points to each of which one or more lines may be attached, including the vehicle line 120, the pulling line 140, the anchor line 125, one or more other lines, or any combination thereof. By configuring the recovery device 115 to have the yoke 145 and corresponding attachment points at the end of the boom 150, the angle at which a pulling force 130 is exerted may include a vertical component, thereby both pulling and lifting the vehicle at the same time with a single pulling force 130.

The recovery device 115 may be used in at least two different scenarios, including the first recovery scenario 100 and the second recovery scenario 101. The first recovery scenario 100 may involve a scenario in which the vehicle 110 is stuck or immobilized in the terrain 105. The terrain 105 may be any terrain, including mud, snow, water, dirt, sand, or any combination thereof. The recovery device 115 may be coupled with the vehicle with the vehicle line 120. The recovery device 115 may be coupled with a pulling line 140, which may be coupled with the pulling force 130-a. The pulling force 130-a may optionally be coupled with the anchor 135 with the anchor line 125. The pulling force 130-a may be any mechanism, entity, device, or force that is capable of exerting a force on the pulling line 140 to rotate the boom 150 and pass the force along the vehicle line 120 to the vehicle 110 to recover the vehicle.

Similarly, the second recovery scenario 101 may involve a scenario in which the vehicle 110 is stuck or immobilized in the terrain 105. However, in the second recovery scenario 101, the pulling force 130-b may be located at, on, or near the vehicle (e.g., a vehicle mounted winch). The pulling force 130-a may be any mechanism, entity, device, or force that is capable of exerting a force on the vehicle line 120 to pull and lift the vehicle 110 out of the terrain 105. The anchor line 125 may be coupled with the recovery device 115 and to the anchor 135. The anchor 135 may be any object capable of acting as an anchor, including a tree, another vehicle, a rock, or any other object. In the second recovery scenario 101, the anchor 135, the anchor line 125, or both, may not permit substantial movement of the recovery device, such that the boom 150 of the recovery device 115 may not rotate (e.g., in a substantial manner) and the pulling force 130-b may lift and pull the vehicle 110 out of the terrain.

Though the first recovery scenario 100 and the second recovery scenario 101 are depicted, elements of the first recovery scenario 100 may be used in the second recovery scenario 101 and elements of the second recovery scenario 101 may be used in the first recovery scenario 100. For example, in some cases, both a pulling force 130-a and the pulling force 130-b may be provided and used in concert (e.g., simultaneously or in turn) to effect recovery of the vehicle 110.

In some examples, the scale of the recovery device 115 may be modified to accommodate different vehicles 110 or situations. For example, for a small ATV, a smaller version of the recovery device 115 may be used, whereas for heavy equipment, a larger version of the recovery device 115 may be employed. This disclosure contemplates any scaling of the recovery device 115 to accommodate different vehicles, terrains, and situations.

The recovery device 115 is depicted in the active state 180, in which the recovery device 115 may be used for recovery operations. However, for travel, storage, or other scenarios, the recovery device 115 may be reconfigured to be in a storage state (e.g., the storage state 480 described herein). For example, the recovery device 115 may be maintained in the storage state until recovery operations are to be performed, at which time the recovery device 115 may be disassembled from the storage state 480 and reassembled into the active state 180.

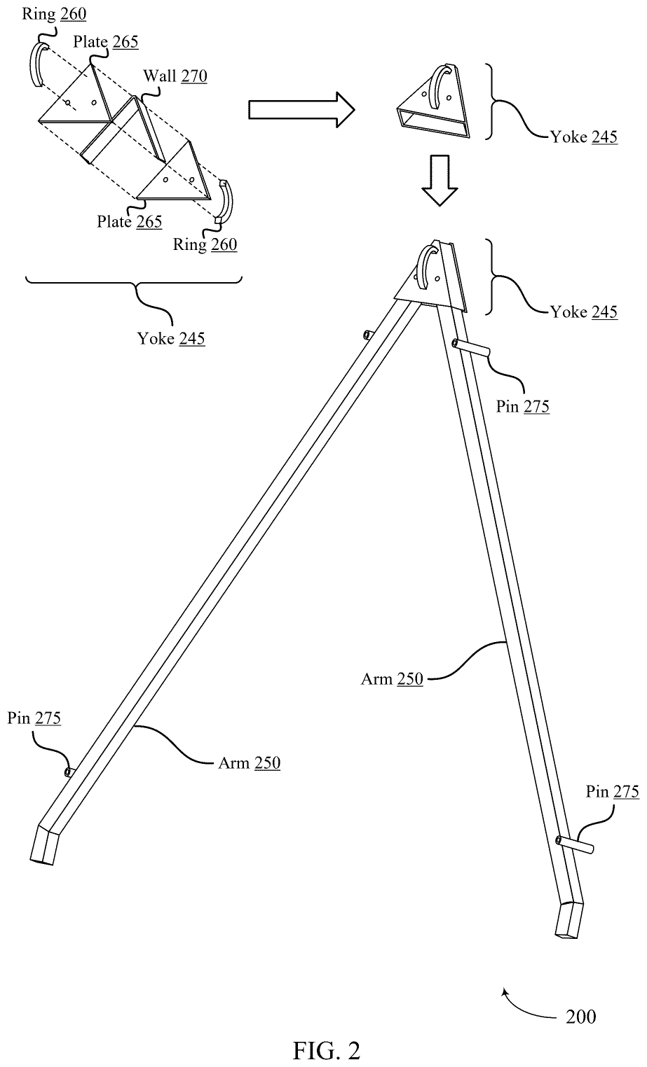

FIG. 2 shows an example of boom 200 of an off-road recovery device that supports off-road recovery devices in accordance with examples as disclosed herein.

The boom 200 may include one or more arms 250. Though two arms 250 are depicted here, a single arm may be employed, or a quantity of arms 250 greater than two may be employed. Regardless of the quantity of arms 250, first ends of the arms 250 may be capable of being coupled with the base (e.g., the base 155). Second ends of the arms 250 may be capable of being coupled with the yoke 245. The yoke 245 may include one or more rings 260 which may serve as attachment points for attaching one or more lines to the boom 200. Though rings 260 are depicted, any type of attachment point capable of receiving one or more lines or coupling the yoke 245 to one or more lines may be used.

In some examples, the yoke 245 may include various elements, including the plates 265 the wall 270, and the rings 260. The yoke 245 may be assembled as shown, with a first ring 260 being coupled (e.g., fixedly coupled such as being welded) with a first plate 265, a second ring 260 being coupled (e.g., fixedly coupled such as being welded) with a second plate 265, and a wall 270 in between the two plates 265. The plates 265 and the wall 270 may form at least a portion of a cavity into which one or more ends of one or more arms 250 may be inserted (e.g., in association with the active state described herein). In some examples, one or more fasteners (e.g., pins, bolts, screws, or other fasteners) or other elements may be used to couple the yoke 245 to the arms 250. For example, the yoke 245 may include one or more holes and the arms 250 may include one or more holes, which may be aligned with the corresponding holes in the yoke 245. The fasteners may pass through the holes of the yoke 245 and the holes of the arms 250 to couple the arms 250 to the yoke 245. In some examples, nuts, pins, or other retention mechanisms may be used to retain the fasteners in the yoke 245 and the arms 250 and to maintain coupling of the arms 250 and the yoke 245.

In some examples, the arms 250 may include or may be coupled with one or more pins 275, which may be used to align and capture the arms 250 in association with the storage state as described herein.

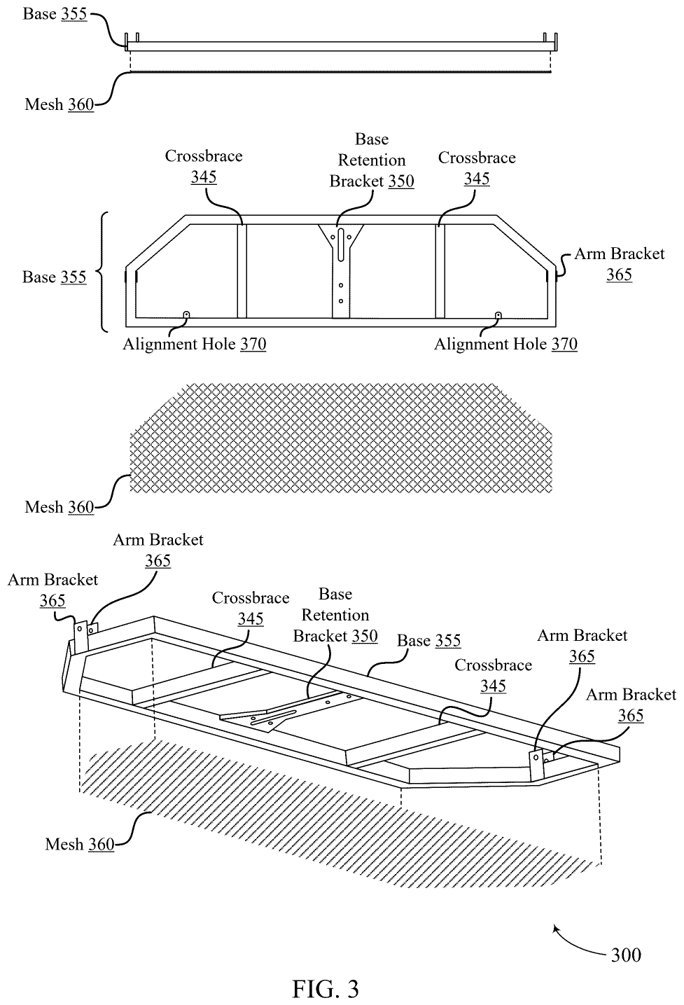

FIG. 3 shows multiple views of an example of a base assembly 300 that supports off-road recovery devices in accordance with examples as disclosed herein.

The base assembly 300 may include a base 355 and a mesh 360. The mesh 360 may be welded, bolted, or otherwise coupled with the base 355. The base 255, the mesh 360, or both, may provide for a larger surface area for the recovery device, thereby dispersing forces received during recovery operations and helping the recovery device to “float” and avoid getting stuck or sinking into the terrain (e.g., in which the vehicle may be stuck).

The base 355 may include various elements, including one or more cross-braces 345 and a base retention bracket 350. The cross-braces 345 may serve to strengthen the base 355 and provide additional surfaces for coupling the mesh 360 to the base 355. The base retention bracket 350 may provide a mechanism for removably coupling other elements of the recovery device in association with the storage state described herein.

The base 355 may include one or more arm brackets 365 that may retain the arms of the boom (e.g., the arms 250 and the boom 150) in association with the active state. For example, the arm brackets 365 may receive one or more bolts, pins, fasteners, axles, or other elements that may retain the arms in the arm brackets 365. The bolts (or other elements) may pass through holes in the arm brackets 365 and holes in the arms to retain the arms. Further, one or more nuts, pins, or other retention mechanisms may be used to retain the bolts or other elements in the arms and the arm brackets 365 and to maintain coupling of the arms 250 and the base 355 (e.g., via the use of the arm brackets 365).

The base 355 may include one or more alignment holes 370 that may receive pins of the arms in association with the storage state as described herein.

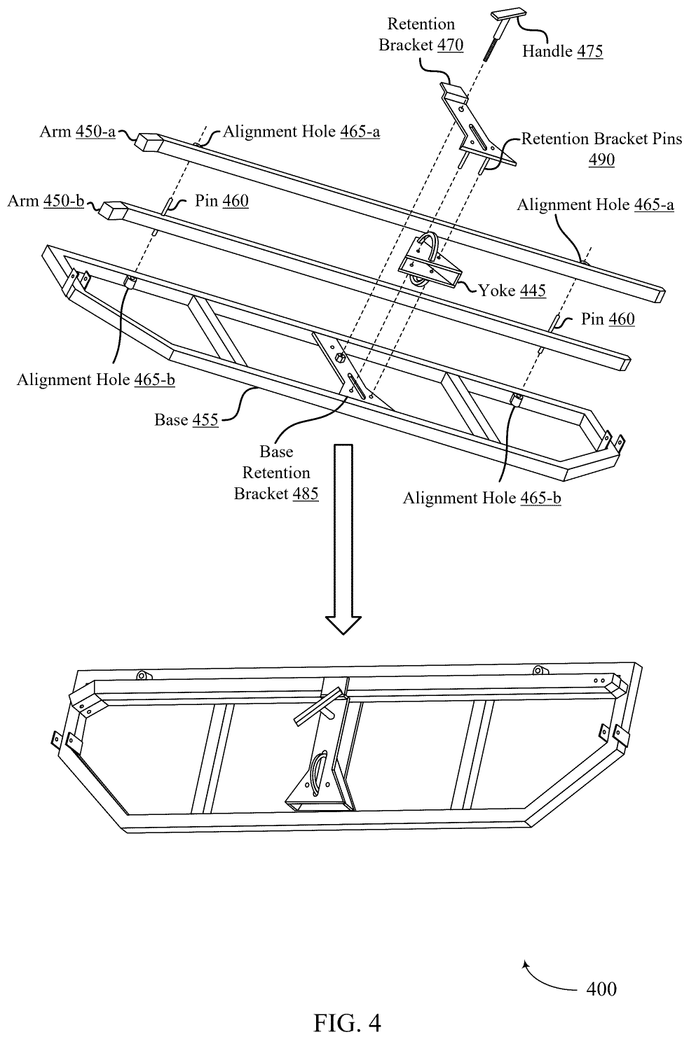

FIG. 4 shows an example of a storage state 400 of a recovery devices in accordance with examples as disclosed herein.

In the storage state 400, the off-road recovery device may be configured for transport, storage, maintenance, or other operations in which the active state of the off-road recovery device may not be appropriate. For example, one may store the off-road recovery device in or on a vehicle and in the storage state 400 while travelling. If a vehicle becomes stuck, the recovery device may then be configured into the active state for recovery operations.

In the storage state 400, the recovery device may be compact and easily stored in or attached to a vehicle. The various elements of the recovery device may be arranged in a “flat-packing” manner to occupy less volume and be easier to handle, transport, or move around. It is to be noted that the mesh described elsewhere herein is omitted in FIG. 4 for clarity.

In some examples (e.g., as shown), the base 455 may include a base retention bracket 485. For example, the base retention bracket 485 may provide one or more holes through which fasteners may be placed to aid in retention of other elements of the recovery device. Similarly, the base retention bracket 485 may include one or more holes or openings to accommodate other elements of the recovery device themselves. For example, the oblong hole may be used to receive a ring of the yoke 445 (e.g., a ring 260), additionally aiding in retention of the yoke 445 in association with the storage state 400.

In some examples, the arms 450, the base 455, or both may include alignment holes 465 that may receive the pins 460 in association with the storage state. For example, the arm 450-a may include the alignment holes 465-a and the arm 450-b may include the pins 460. The pins 460 may be received by the alignment holes 465-a of the arm 450-a and may be further received by the alignment holes 465-b of the base 455. In at least these ways, parallel movement of the arms 450 and the base 455 relative to one another may be restricted and the arms 450 may be retained with the base 455 at least partially due to the pins 460 and the alignment holes 465.

In some examples, the retention bracket 470 may be used to aid in retention of the yoke 445 and the arms 450 with the base 455. For example, the retention bracket 470 may include one or more retention bracket pins 490 that may be received by one or more holes in the yoke and one or more holes in the base retention bracket 485. Further, the retention bracket 470, the base retention bracket 485, or both, may include one or more openings to accommodate the rings or other elements of the yoke 445 (e.g., to which the lines are attached in association with the active state) in association with the storage state 400. For example, each of the retention bracket 470 and the base retention bracket 485 may include an oblong hole into which oppositely facing rings of the yoke 445 may be received in association with the storage state 400.

In some examples, the handle 475 may be used to retain the retention bracket 470 against the arms 450 and the yoke 445, thereby retaining the arms 450 and the yoke 445 against the base 455. For example, the handle 475 may include a threaded or unthreaded rod or portion that may thread or enter into a threaded or unthreaded opening to apply a retention force. For example, after the base 455, the arms 450, the yoke 445, and the retention bracket 470 are placed together as depicted and described herein in association with the storage state 400, the handle 475 may be placed to pass through the retention bracket 470 and into a receiving portion (e.g., the threaded or unthreaded opening) of the base retention bracket 485. In the case of a threaded rod on the handle 475, a threaded opening, or both, the handle 475 may be screwed into the threaded opening. In the case of an unthreaded rod of the handle 475, and unthreaded opening, or both, the handle 475 may be retained by any other means.

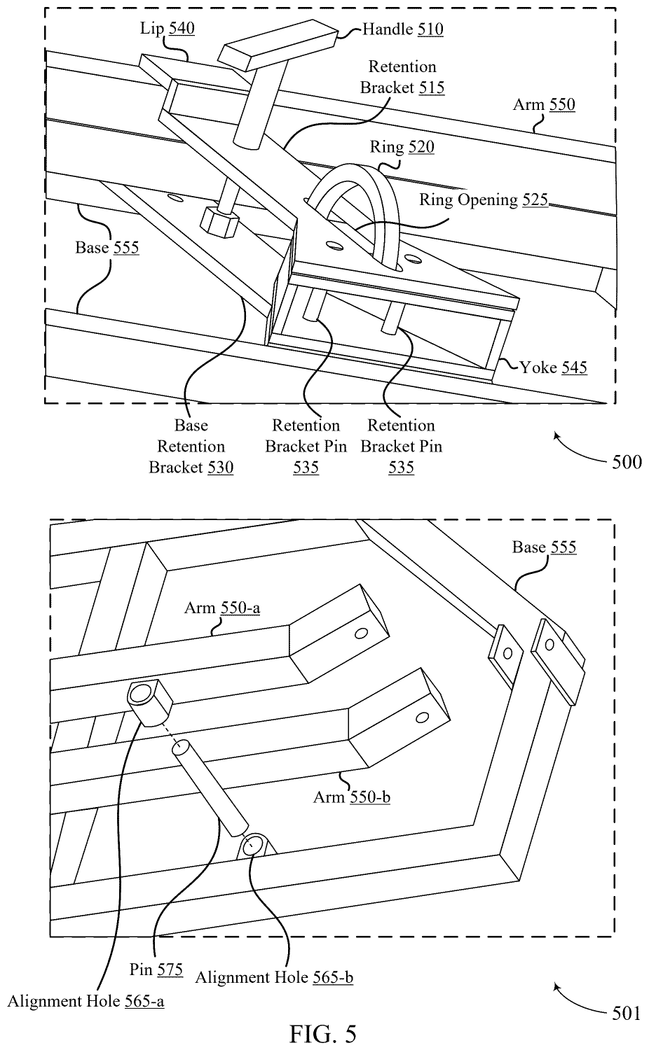

FIG. 5 shows an example of a storage state 500 and a storage state 501 of an off-road recovery devices in accordance with examples as disclosed herein.

The storage state 500 depicts a detail view of the retention bracket 515, the yoke 545, the base retention bracket 530, and the base 555 in association with the storage state. For example, as shown the base retention bracket 530 may receive a portion of the yoke 545 (e.g., a ring of the yoke 545 not seen due to the perspective of the figure, but that is located opposite of the ring 520). Similarly, the retention bracket 515 may include a ring opening 525 that may receive the ring 520. The retention bracket 515 may include one or more retention bracket pins 535, which may be pins, screws, bolts, or other elements that may assist in alignment and retention of the retention bracket 515, the yoke 545, and the base retention bracket 530. Further, the handle 510, may provide a retention force to retain the yoke 545 and the arms 550 in the storage state 500. In some examples, the lip 540 of the retention bracket 515 may be used to aid in retaining the arms 550. In some examples, the lip 540 may be on a different, yet parallel plane to another portion of the retention bracket 515.

The storage state 501 depicts a detail view of the pins 575 of the arm 550-b and the alignment holes 565, including the alignment holes 565-a of the arm 550-a and the alignment holes 565-b of the base 555. In some examples, the alignment holes 565 may receive the pins 575 to aid in retention of the arms 550 and reduce parallel movement of the arm 550-a, the arm 550-b, and the base 555 relative to one another.

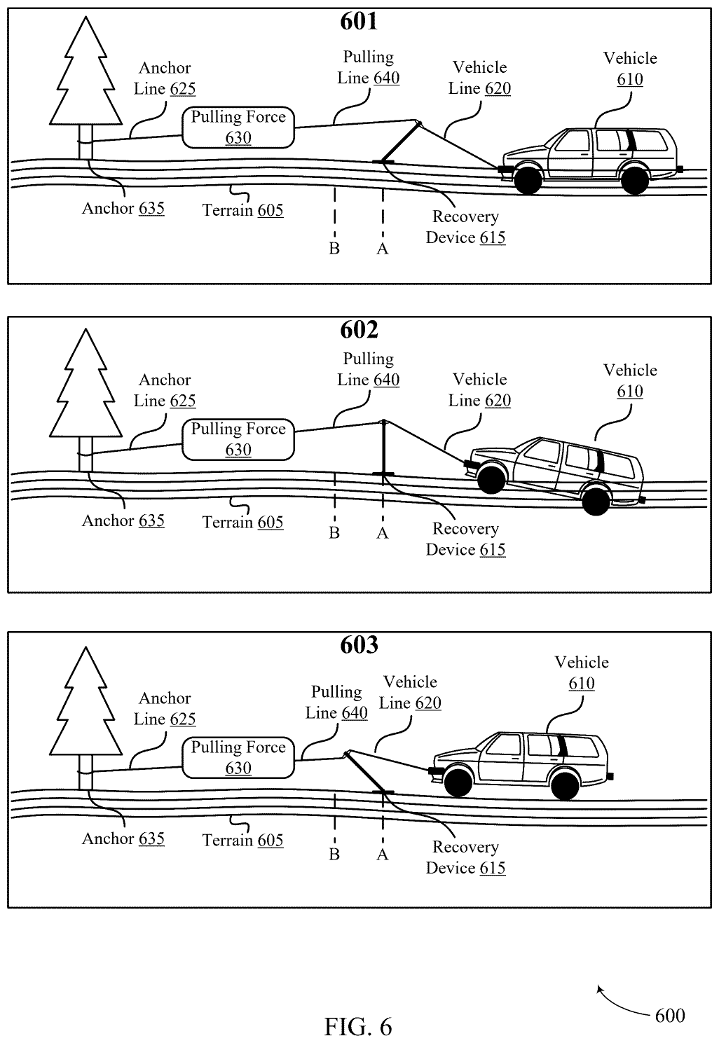

FIG. 6 shows an example of a recovery scenario 600 that supports off-road recovery devices in accordance with examples as disclosed herein.

The first recovery scenario 600 may involve a scenario in which the vehicle 610 is stuck or immobilized in the terrain 605. The terrain 605 may be any terrain, including mud, snow, water, dirt, sand, or any combination thereof. The recovery device 615 may be coupled with the vehicle with the vehicle line 620. The recovery device 615 may be coupled with a pulling line 640, which may be coupled with the pulling force 630-a. The pulling force 630 may optionally be coupled with the anchor 635 with the anchor line 625. Additionally, or alternatively, the pulling force 630 may be mounted to another element that may act as an anchor (e.g., another vehicle, directly on the anchor 635, or elsewhere). The pulling force 630 may be any mechanism, entity, device, or force that is capable of exerting a force on the pulling line 640 to rotate the boom 650 and pass the force along the vehicle line 620 to the vehicle 610 to recover the vehicle.

At 601, the vehicle 610 may be stuck in the terrain 605. This may represent the initial arrangement at which recovery operations begin. The recovery device 615 may be placed at the location marked as A. In some examples, the recovery device 615 may be initially configured to place the boom at an angle (e.g., 40 degrees) towards the vehicle 610, providing an extended range of motion of the boom as it rotates away from the vehicle 610 as a result of the pulling force 630 being applied.

At 602, the pulling force 630 has been exerted on the pulling line 640 (e.g., optionally anchored to the anchor 635 with the anchor line 625), rotating the boom of the recovery device 615 and transferring the force along the vehicle line 620 to the vehicle 610. The vehicle 610 is partially extracted, but is still stuck in the terrain 605. At this point, the boom is extended substantially vertically (e.g., substantially perpendicular to the base of the recovery device 615). However, the boom may still rotate further away from the vehicle 610, providing additional pulling and lifting opportunities.

At 603, the pulling force 630 has been further exerted on the pulling line 640 (e.g., the pulling force 630 being optionally anchored to the anchor 635 with the anchor line 625). The boom of the recovery device 615 has been further rotated away from the vehicle 610 (e.g., now at an approximate angle of 140 degrees). At this point, the vehicle 610 been extracted from the terrain 605.

However, if the vehicle has not yet been extracted, the process may be repeated once again (or as many times as desired). For example, after reaching 603, the recovery device 615 may be moved from point A to point B, and 601, 602, and 603 may be repeated with the recovery device 615 in the new position of point B. Such an approach may avoid the cumulative “plowing” effects that would otherwise continually increase as a traditional, horizontal, bumper-level pull is performed.

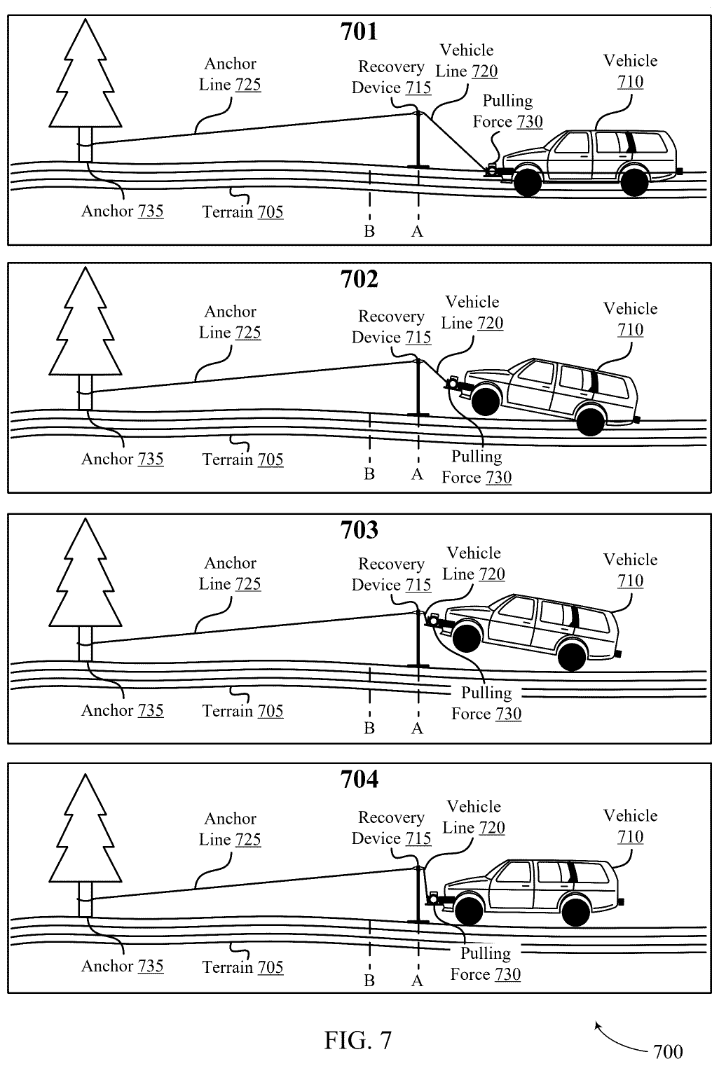

FIG. 7 shows an example of second recovery scenario 700 that supports off-road recovery devices in accordance with examples as disclosed herein.

The second recovery scenario 701 may involve a scenario in which the vehicle 710 is stuck or immobilized in the terrain 705. However, in the second recovery scenario 701, the pulling force 730 may be located at, on, or near the vehicle (e.g., a vehicle mounted winch or other pulling force that may be coupled with the vehicle or the vehicle line 720). The pulling force 730 may be any mechanism, entity, device, or force that is capable of exerting a force on the vehicle line 720 to pull and lift the vehicle 710 up and out of the terrain 705. The anchor line 725 may be coupled with the recovery device 715 and to the anchor 735. The anchor 735 may be any object capable of acting as an anchor, including a tree, another vehicle, a rock, or any other object. In the second recovery scenario 701, the anchor 735, the anchor line 725, or both, may not permit substantial movement of the recovery device, such that the boom 750 of the recovery device 715 may not rotate (e.g., in a substantial manner) and the pulling force 730 may lift and pull the vehicle 710 out of the terrain.

At 701, the vehicle 710 may be stuck in the terrain 705. This may represent the initial arrangement at which recovery operations begin. The recovery device 715 may be placed at the location marked as A. In some examples, the recovery device 715 may have the boom placed in a substantially perpendicular position to the base. However, the operations described herein are equally applicable to situations in which the boom is placed at a different angle relative to the base.

In any case, independent of the angle, the recovery device 715 may be used in a manner in which the boom is kept relatively stationary throughout the recovery operations. In some examples, in order to access better traction, the direction of pull can also be altered. In some cases, is may be desirable to maintain a straight line between the vehicle 710 and the anchor 735 (e.g., along the vehicle line 720 and the anchor line 725) and have the vehicle travel straight along that line. However, in some situations, it may not be possible to do so. As such, in some situations, the orientation of the straight line may not be along the long axis of the vehicle (e.g., the long axis of the vehicle and the straight line may not be substantially parallel), though, in some cases, the straight line between the vehicle 710 and the anchor 735 (e.g., along the vehicle line 720 and the anchor line 725) may be maintained.

At 702, the pulling force 730 has been applied and the vehicle 710 has begun to be pulled and lifted out of the terrain 705. At this point, additional force (e.g., the pulling force 730 applied along the vehicle line 720) may still be exerted to further pull and lift the vehicle 710 up and out of the terrain 705.

At 703, the pulling force 730 has reached a limit of travel near the top of the recovery device 715, and the wheels closest to the recovery device 715 are in the air. At this point, it may not be possible to continue applying the pulling force 730 along the vehicle line 720.

At 704, the tension from the pulling force 730 may be released, allowing the wheels closest to the recovery device 715 to return to the terrain 705. At this point, the vehicle 710 has been extracted from the terrain 705.

However, if the vehicle has not yet been extracted, the process may be repeated once again (or as many times as desired). For example, after reaching 704, the recovery device 715 may be moved from point A to point B, and 701, 702, 703, and 704 may be repeated with the recovery device 715 in the new position of point B. In some examples, after moving the recovery device 715 to point B, the substantially vertical angle (e.g., parallel to the base) or another angle used may be maintained or selected for use for the subsequent repetitions of the operations. Such an approach may avoid the cumulative “plowing” effects that would otherwise continually increase as a traditional, horizontal, bumper-level pull is performed.

An apparatus for recovery of a vehicle is described. The apparatus may include a base, a boom that extends away from the base and is rotatably and removably coupled, at a first end, to the base, a yoke removably coupled with the boom at a second end of the boom, and a plurality of line attachment points coupled with the yoke, wherein a first line attachment point of the plurality of line attachment points that is coupled with a first side of the yoke receives a first line coupled with the vehicle, and wherein a second line attachment point of the plurality of line attachment points that is coupled with a second side of the yoke receives a second line coupled with a first anchor point.

In some examples of the apparatus, the first line attachment point may be a second anchor point for a force received along the first line from a pulling device that may be located on the vehicle and that may be coupled with the first line.

In some examples of the apparatus, the second line attachment point receives, from a pulling device coupled with the second line, a force that rotates the boom towards the second side of the yoke, the yoke transfers the force to the vehicle via the first line attachment point and the first line, and the first anchor point may be an anchor point for the force.

In some examples of the apparatus, the first side of the yoke may be opposite the second side of the yoke.

In some examples of the apparatus, the boom comprises a plurality of arms and each arm of the plurality of arms may be removably coupled with the base at a respective first end of a respective arm and may be removably coupled with the yoke at a respective second end of the respective arm.

In some examples of the apparatus, a first arm of the plurality of arms comprises a plurality of pins, a second arm of the plurality of arms comprises a first plurality of holes that accept first ends of the plurality of pins when the apparatus may be in a storage state, and the base comprises a second plurality of holes that accepts second ends of the plurality of pins when the apparatus may be in the storage state.

Some examples of the apparatus may further include a first retention bracket that, accepts a retention member that removably couples the first retention bracket to a second retention bracket comprised in the base when the apparatus may be in the storage state, retains the first arm against the base with the second ends of the plurality of pins received in the second plurality of holes of the base when the apparatus may be in the storage state, and retains the second arm against the first arm with the first ends of the plurality of pins received in the first plurality of holes of the second arm when the apparatus may be in the storage state.

In some examples of the apparatus, the second retention bracket comprises a first opening that accepts the first line attachment point of the plurality of line attachment points, the first retention bracket comprises a second opening that accepts the second line attachment point of the plurality of line attachment points, and the first retention bracket retains the yoke against the second retention bracket with the first line attachment point received in the first opening and the second line attachment point received in the second opening.

In some examples of the apparatus, the first retention bracket comprises one or more pins that may be received by corresponding one or more first alignment holes in the yoke and that may be further received by one or more second alignment holes in the second retention bracket.

In some examples of the apparatus, the second retention bracket may be centrally located along a first axis of the base.

In some examples of the apparatus, the second retention bracket may be fixed to the base.

In some examples of the apparatus, the base comprises a plurality of outer members along a perimeter of the base, a plurality of cross members, each cross member coupled with multiple outer members, and a planar member coupled with one or more outer members, one or more cross members, or any combination thereof.

In some examples of the apparatus, the planar member comprises a mesh material.

In some examples of the apparatus, the boom pivots around an axis substantially parallel to a plane of the base.

In some examples of the apparatus, the first anchor point may be stationary.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for recovery of a vehicle, comprising:
a base;
a boom that extends away from the base and is rotatably and removably coupled, at a first end, to the base;
a yoke removably coupled with the boom at a second end of the boom; and
a plurality of line attachment points coupled with the yoke, wherein a first line attachment point of the plurality of line attachment points that is coupled with a first side of the yoke receives a first line coupled with the vehicle, and wherein a second line attachment point of the plurality of line attachment points that is coupled with a second side of the yoke receives a second line coupled with a first anchor point.

2. The apparatus of claim 1, wherein:
the first line attachment point is a second anchor point for a force received along the first line from a pulling device that is located on the vehicle and that is coupled with the first line.

3. The apparatus of claim 1, wherein:
the second line attachment point receives, from a pulling device coupled with the second line, a force that rotates the boom towards the second side of the yoke;
the yoke transfers the force to the vehicle via the first line attachment point and the first line; and
the first anchor point is an anchor point for the force.

4. The apparatus of claim 1, wherein:
the first side of the yoke is opposite the second side of the yoke.

5. The apparatus of claim 1, wherein:
the boom comprises a plurality of arms; and
each arm of the plurality of arms is removably coupled with the base at a respective first end of a respective arm and is removably coupled with the yoke at a respective second end of the respective arm.

6. The apparatus of claim 5, wherein:
a first arm of the plurality of arms comprises a plurality of pins;
a second arm of the plurality of arms comprises a first plurality of holes that accept first ends of the plurality of pins when the apparatus is in a storage state; and
the base comprises a second plurality of holes that accepts second ends of the plurality of pins when the apparatus is in the storage state.

7. The apparatus of claim 6, further comprising:
a first retention bracket that:
accepts a retention member that removably couples the first retention bracket to a second retention bracket comprised in the base when the apparatus is in the storage state,
retains the first arm against the base with the second ends of the plurality of pins received in the second plurality of holes of the base when the apparatus is in the storage state, and
retains the second arm against the first arm with the first ends of the plurality of pins received in the first plurality of holes of the second arm when the apparatus is in the storage state.

8. The apparatus of claim 7, wherein:
the second retention bracket comprises a first opening that accepts the first line attachment point of the plurality of line attachment points;
the first retention bracket comprises a second opening that accepts the second line attachment point of the plurality of line attachment points; and
the first retention bracket retains the yoke against the second retention bracket with the first line attachment point received in the first opening and the second line attachment point received in the second opening.

9. The apparatus of claim 8, wherein:
the first retention bracket comprises one or more pins that are received by corresponding one or more first alignment holes in the yoke and that are further received by one or more second alignment holes in the second retention bracket.

10. The apparatus of claim 7, wherein:
the second retention bracket is centrally located along a first axis of the base.

11. The apparatus of claim 7, wherein:
the second retention bracket is fixed to the base.

12. The apparatus of claim 1, wherein the base comprises:
a plurality of outer members along a perimeter of the base;
a plurality of cross members, each cross member coupled with multiple outer members; and
a planar member coupled with one or more outer members, one or more cross members, or any combination thereof.

13. The apparatus of claim 12, wherein:
the planar member comprises a mesh material.

14. The apparatus of claim 1, wherein:
the boom pivots around an axis substantially parallel to a plane of the base.

15. The apparatus of claim 1, wherein:
the first anchor point is stationary.
